(19) United States
(12) Patent Application Publication
(10) Pub. No.: US 2003/0153367 A1
(43) Pub. Date: Aug. 14, 2003

(54) Earphone/car audio system dual receiving mode type cellular telephone hand-free handset

(76) Inventor: Ko Lee Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/073,004

(22) Filed: Feb. 12, 2002

(51) Int. Cl. H04M 1/00

(52) U.S. Cl. 455/569; 455/568

(57) ABSTRACT

An earphone/car audio system dual receiving mode type cellular telephone hand-free handset for use with a cellular telephone in a car in which a selector switch is provided and selectively switched between a car audio system receiving mode where the voice output signal is transmitted to a radio transmitter circuit that modulates the signal and then transmit the signal to the car audio system by radio for broadcasting, and a earphone receiving mode where the voice output signal is transmitted to the earphone for the user only and the battery power circuit is cut off from the radio transmitter circuit.

### BACKGROUND OF THE INVENTION

1. Field of the Invention

The present invention relates to a cellular telephone handfree handset and, more particularly, to an earphone/car audio system dual receiving mode type cellular telephone hand-free handset.

2. Description of the Related Art

FIG. 1 shows a cellular telephone hand-free handset according to the prior art. This structure of cellular telephone hand-free handset comprises a connector 30′, which is connected to the voice input output jack of a cellular telephone for voice signal input and output, an earphone 10′ connected to the connector 30′ for voice signal output from the cellular telephone to the user's ear, a microphone 20′ connected to the connector for voice signal input from the user to the cellular telephone, and a clip 40′ mounted on the cable between the connector 30′ and the microphone 20′ for positioning. When driving the car, the user may be unable to hear the voice from the earphone 10′ clearly. There are known cellular telephone hand-free handset that enables the output voice signal of the cellular telephone to be transmitted to the car audio system by radio and then broadcasted through the speakers of the car audio system. However, these cellular telephone hand-free handsets cannot prohibit other people in the car from sharing the message.

### SUMMARY OF THE INVENTION

The present invention has been accomplished under the circumstances in view. It is therefore the main object of the present invention to provide a cellular telephone hand-free handset, which provides an earphone receiving mode and a car audio system receiving mode so that the user can selectively control the voice output to the earphone or the car audio system. According to one aspect of the present invention, the earphone/car audio system dual receiving mode type cellular telephone hand-free handset comprises a connector connected to the cellular telephone for voice signal input and output, an earphone connected to the connector for voice signal output, and a frequency changer connected between the earphone and the connector for controlling the transmission of cellular telephone voice output signal to the earphone. According to another aspect of the present invention, the frequency changer comprises a battery circuit, which provides the cellular telephone hand-free handset with the necessary working power, a radio transmitter circuit adapted to convert cellular telephone voice output signal into radio signal and then transmit it to the car audio system by radio, and a selector switch adapted for controlling the transmission route of cellular telephone voice output signal between the earphone and the radio transmitter circuit.

### BRIEF DESCRIPTION OF THE DRAWINGS

FIG. 1 is a cellular telephone hand-free handset according to the prior art.

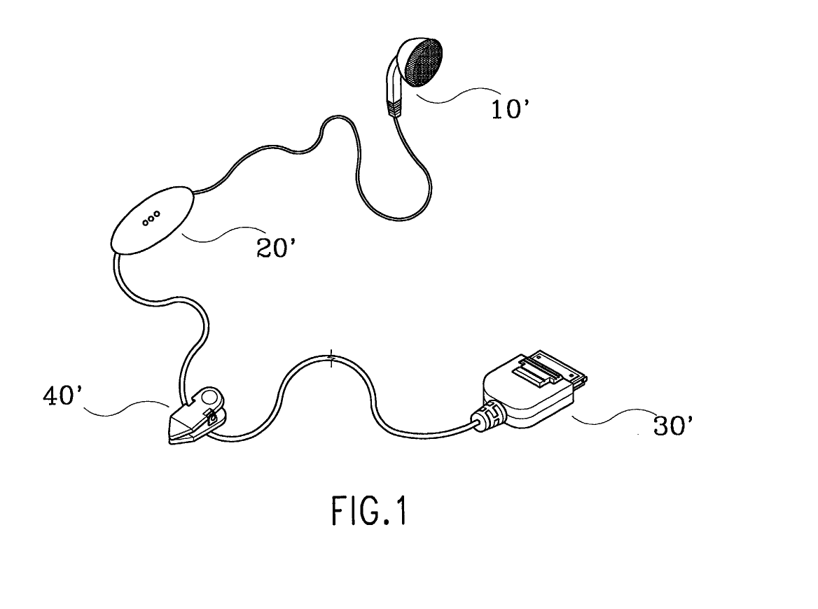

FIG. 2 illustrates an earphone/car audio system dual receiving mode type cellular telephone hand-free handset according to the present invention.

FIG. 3 is an exploded view of the frequency changer of the earphone/car audio system dual receiving mode type cellular telephone hand-free handset according to the present invention.

FIG. 4 illustrates the backside structure of the frequency changer of the earphone/car audio system dual receiving mode type cellular telephone hand-free handset according to the present invention.

FIG. 5 illustrates the connector of the frequency changer of the earphone/car audio system dual receiving mode type cellular telephone hand-free handset connected to the audio signal input output jack of a cellular telephone according to the present invention.

FIG. 6 is a schematic drawing showing the action of the frequency changer when switched to the car audio system receiving mode.

FIG. 7 is a circuit diagram of the frequency charger according to the present invention.

### DETAILED DESCRIPTION OF THE PREFERRED EMBODIMENT

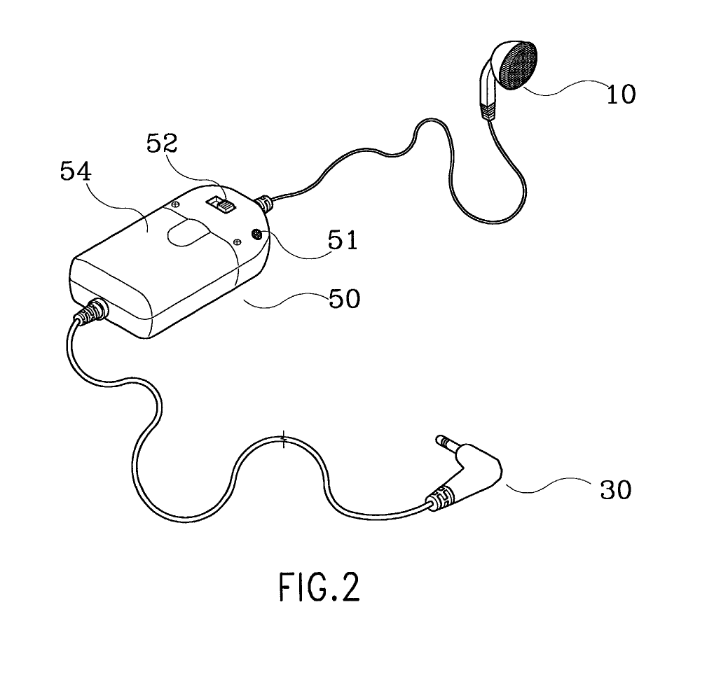

Referring to FIG. 2, an earphone/car audio system dual receiving mode type cellular telephone hand-free handset in accordance with the present invention is shown comprised of an earphone 10, a connector 30 for connecting to a voice signal input output jack of a cellular telephone, and a frequency changer 50 connected between the earphone 10 and the connector 30. The frequency changer 50 comprises a selector switch 52 and a microphone hole 51. The selector switch 52 controls the voice output from the connector 30 (the cellular telephone to which the connector is connected) to the earphone 10 or the car audio system (not shown) selectively.

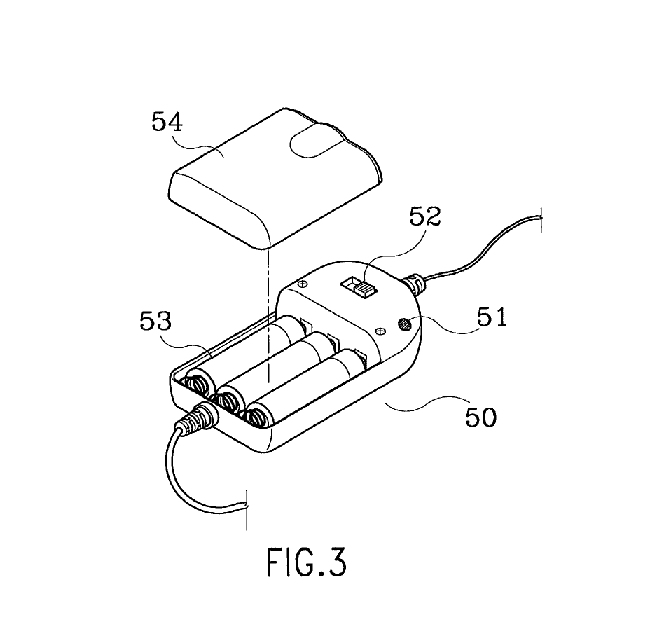

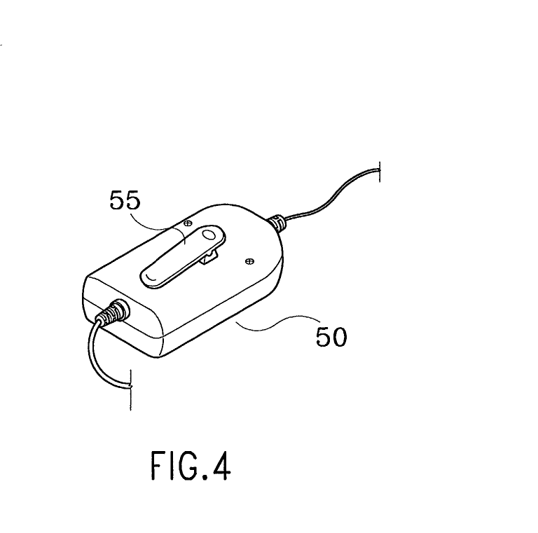

Referring to FIGS. 3 and 4, the frequency changer 50 comprises further a battery chamber 53 holding three battery cells of model AAA, a lid 54 covering the battery chamber 53, and a clip 55 provided at the back sidewall thereof and adapted for fastening the frequency changer 50 to the pocket or collar of the user's cloths.

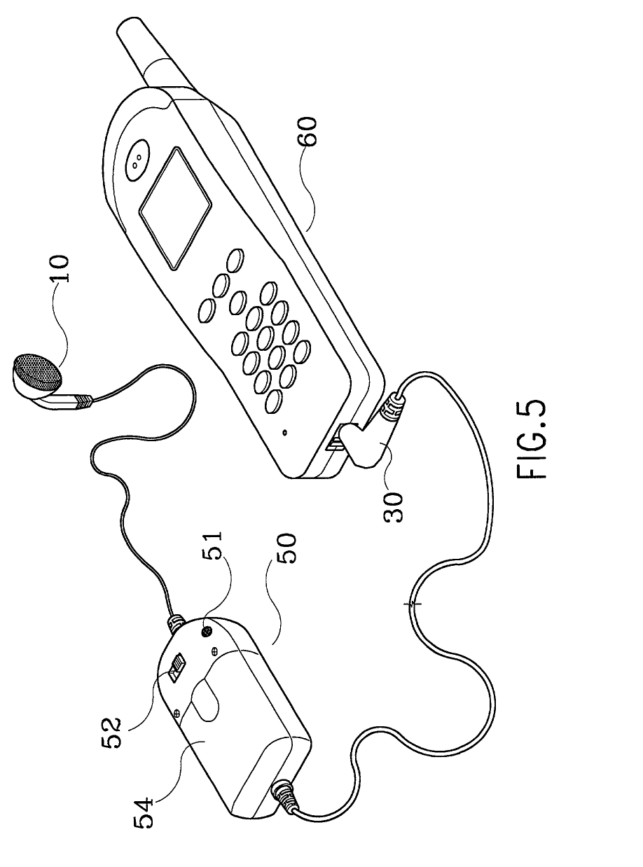

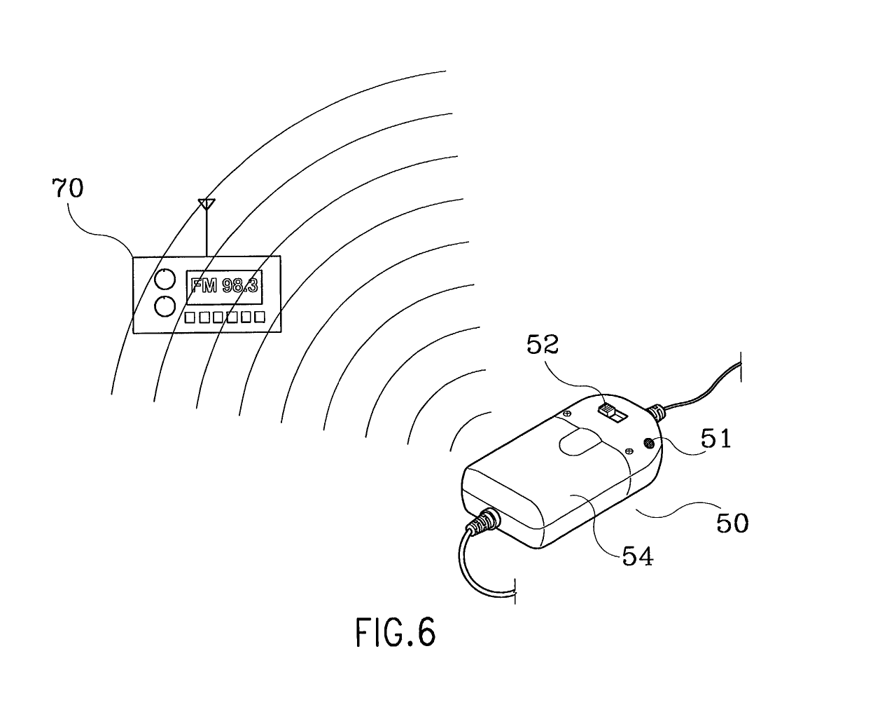

Referring to FIGS. 5 and 6, when in use, the connector 30 is connected to the voice signal input output jack of the cellular telephone 60, the earphone 10 is fastened to the ear, and the selector switch 52 is switched to the mode where the voice output of the cellular telephone 60 is allowed to pass from the connector 30 to the earphone 10 (see FIG. 5). At this time, the user receives voice from the cellular telephone 60 through the earphone 10, and the voice of the user is picked up by a microphone (not shown) in the microphone hole 51 and transmitted to the cellular telephone 60 through the connector 30. When the user switched the selector switch 52 to the mode where the voice output of the cellular telephone 60 is allowed to pass from the connector 30 to the car audio system 70 (see FIG. 6), the frequency changer 50 converts the voice output signal from the cellular telephone 60 into a radio signal and then transmits the radio signal to the car audio system 70 by air, enabling the car audio system 70 to receive and broadcast the radio signal.

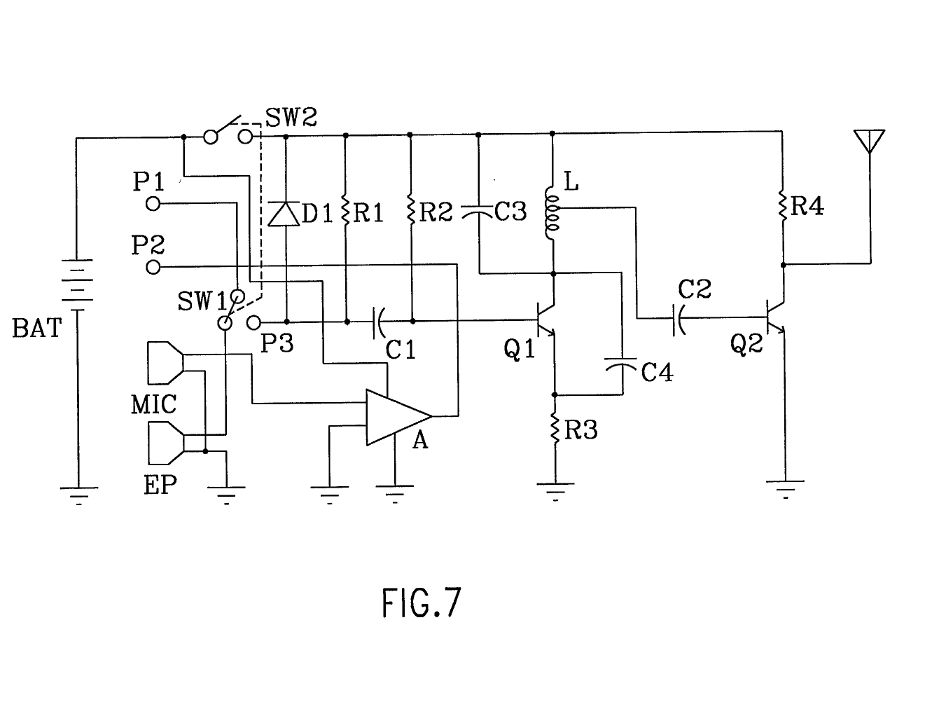

Referring to FIG. 7 and FIGS. 5 and 6 again, the frequency changer 50 comprises a radio transmitter circuit and a microphone amplifier circuit A. The radio transmitter circuit comprises a transistor Q1 adapted to amplify the audio signal received from the cellular telephone 60 through the connector 30, a LC oscillation circuit formed of capacitors C3 and C4 and an inductor L and adapted to modulate the amplified audio signal into a radio signal, a transmitting transistor Q2 adapted to transmit the radio signal from the LC oscillation circuit into the air through a radio antenna connected thereto, enabling the radio signal to be received by the radio receiver of the car audio system 70. The working power of the radio transmitter circuit is obtained from the three battery cells (4.5V) in the battery chamber 53. The signal input terminal, referenced by P1 of the frequency changer 50 is connected to the voice signal output contact of the voice signal input output jack of the cellular telephone 60 via the connector 30. The microphone amplifier circuit A (which obtains the necessary working power from the three battery cells (4.5V) in the battery chamber 53) has a signal output terminal P2 connected to the voice signal input contact of the voice signal input output jack of the cellular telephone 60 via the connector 30.

The selector switch 52 of the frequency changer 50 comprises two linked switches SW1 and SW2. One switch SW1 is connected between the signal input terminal P1 and the signal input contact of the earphone EP and the signal input contact P3 of the radio transmitter circuit. The other switch SW2 is installed in the battery power circuit. When the selector switch 52 switched to the earphone receiving mode, the switches SW1 and SW2 are off, enabling the voice output signal of the cellular telephone 60 to be directly transmitted to the earphone EP, and at this time the radio transmitter circuit does no work. On the contrary, when the selector switch 52 switched to the car audio system receiving mode, the switches SW1 and SW2 are on, i.e., the signal input terminal P3 of radio transmitter circuit is electrically connected to the voice signal output contact of the voice signal input output jack of the cellular telephone 60, enabling the radio transmitter circuit of the frequency changer 50 to module the voice output signal of the cellular telephone 60 into a radio signal and then to transmit the radio signal to into the air, enabling the radio signal to be further received by the radio receiver of the car audio system 70 for output through the speakers of the car audio system 70.

With respect to voice output, either at the earphone receiving mode or the car audio system receiving mode, the user's voice is picked up by the microphone MIC in the microphone hole 51 of the frequency changer 50, then amplified by the amplifier A, and then transmitted the signal output terminal P2 to the voice signal input contact of the voice signal input output jack of the cellular telephone 60 through the connector 30.

A prototype of cellular telephone hand-free handset has been constructed with the features of FIGS. 2˜7. The cellular telephone hand-free handset functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cellular telephone hand-free handset comprising a
a connector connected to the voice signal input output jack of a cellular telephone for voice signal input output;
an earphone adapted to receive voice signal from said cellular telephone through said connector; and
a frequency changer connected between said connector and said earphone, said frequency changer comprising a battery circuit, which provides the cellular telephone hand-free handset with the necessary working power, a microphone amplifier circuit adapted to pick up the user's voice and convert the voice into a voice signal and transmit the voice signal to said cellular telephone through said connector for output, a radio transmitter circuit adapted to convert voice signal outputted from said cellular telephone into a radio signal and to transmit the radio signal into the air for receiving by a car audio system, and a selector switch adapted for controlling the output voice signal of said cellular telephone from said connector to said earphone and said radio transmitter circuit selectively, wherein said selector switch comprises a first switch, said first switch having a common contact connected to said connector and a second contact switched between a signal input contact of said radio transmitter circuit and a signal input contact of said earphone for enabling the output voice signal of said cellular telephone to be selectively transmitted to said radio transmitter circuit/said earphone, and a second switch linked to said first switch and connected between said battery circuit and said radio transmitter circuit and adapted to cut off power supply from said radio transmitter circuit when said first switch switched off the connection between said connector and said radio transmitter circuit and switched on the connection between said connector and said earphone.
